(19) United States
(12) Patent Application Publication
(10) Pub. No.: US 2013/0204861 A1
(43) Pub. Date: Aug. 8, 2013

(54) METHOD AND APPARATUS FOR FACILITATING FINDING A NEAREST NEIGHBOR IN A DATABASE

(71) Applicant: Armand Erik Prieditis, Mountain View, CA (US)

(72) Inventor: Armand Erik Prieditis, Mountain View, CA (US)

(73) Assignee: QUOVA, INC., MOUNTAIN VIEW, CA (US)

(21) Appl. No.: 13/365,735

(22) Filed: Feb. 3, 2012

(51) Int. Cl. G06F 17/30

(52) U.S. Cl. 707/716; 707/E17.012; 707/E17.017

(57) ABSTRACT

A method and apparatus for facilitating finding a nearest neighbor in a database. Example embodiments include: accessing a database tree having a plurality of nodes; receiving information indicative of a query point and information indicative of a node in the database tree; determining, by use of a processor, a lower-bound estimate based on the node and the query point, wherein the lower-bound estimate corresponds to a distance from the query point to the node; determining, by use of the processor, a temporary result corresponding to a distance to a nearest neighbor based on at least one child node of the node, the query point, and the lower-bound estimate; pruning one or more of the plurality of nodes based on the lower-bound estimate and a pruning bound; and returning a result indicative of a nearest neighbor of the query point.

### TECHNICAL FIELD

Various embodiments illustrated by way of example relate generally to the field of data processing and, more specifically, to a method and apparatus for facilitating finding a nearest neighbor in a database.

### BACKGROUND

Previous approaches to finding a nearest neighbor in a database involve branch-and-bound search through a database, which has been space-partitioned into a tree of nodes for faster search. These approaches first determine an initial upper-bound on the distance from the query to a nearest neighbor. Many techniques can be used to find an initial upper-bound, but one popular one is to randomly select a row in the database and determine the distance from that row to a query point. Because the row was randomly selected, the distance is guaranteed to be an upper-bound. Once this initial upper-bound is found, the tree can be searched using branch-and-bound as follows: prune all nodes whose lower-bound estimate is greater than the current upper-bound. As soon as a row is found whose distance is less than the current upper-bound, the current upper-bound is reset to that distance, search terminates for all other branches, and the process repeats with this tighter bound. Thus, this approach searches through the tree with increasingly tighter upper-bounds. When the upper-bound cannot be further tightened, the nearest neighbor has been found. Typically, the lower-bound at a node corresponds to a distance from the query to a hyper-rectangular region at the node, where the hyper-rectangular region that characterizes the rows below that node. This approach can result in a search time that is proportional to a logarithm of the number of rows in the database, thus significantly improving over exhaustive search. However, many nodes are searched whose distance is greater than the distance to the nearest node, thus resulting in inefficiency. Previous approaches search more of the nearest neighbor tree than is necessary.

### BRIEF DESCRIPTION OF THE DRAWINGS

Embodiments are illustrated by way of example and not limitation in the figures of the accompanying drawings, in which like references indicate similar elements and in which:

FIG. 1 illustrates a network diagram depicting a system having a database query source in network communication with a database query processor and a database via a data network, according to an example embodiment;

FIG. 2 illustrates an overall view of the processing performed by an example embodiment;

FIGS. 3-5 illustrate a flowchart showing the processing flow for facilitating finding a nearest neighbor in a database in an example embodiment;

FIG. 6 illustrates an example embodiment to determine the distance at a leaf node;

FIGS. 7 and 8 illustrate an example embodiment with a driver which iterates the pruning bound from high to low;

FIG. 9 illustrates a processing flow used in an example embodiment; and

FIG. 10 shows a diagrammatic representation of a machine in the example form of a computer system.

### DETAILED DESCRIPTION

According to an example embodiment, a method and apparatus for facilitating finding a nearest neighbor in a database is described. Other features will be apparent from the accompanying drawings and from the detailed description that follows. In the following description, for purposes of explanation, numerous specific details are set forth in order to provide a thorough understanding of embodiments. It will be evident, however, to one of ordinary skill in the art that the present description may be practiced without these specific details.

### Overview

According to various example embodiments described herein, the disclosed system and method solves the problem of finding a nearest neighbor in a database. Particular embodiments solve the problem of finding a nearest neighbor in a database based on a query. The database can comprise one or more rows of information, where each row can be a vector, a matrix, or any other data structure. The “nearest” neighbor is one with a least distance to the query based on a distance metric such as Euclidean distance. Finding a “nearest” neighbor is important because finding nearest neighbors in a database can arise in a variety of applications, including: content-based image retrieval, DNA sequencing, traceroute analysis, data compression, recommendation systems, internet marketing, handwriting analysis, classification and prediction, cluster analysis, plagiarism detection, and the like. In content-based image retrieval, the query might correspond to a particular set of red, green, and blue pixel values of a desired image. When the database contains billions of images, each with millions of pixels, finding the nearest neighbor can be difficult.

The various example embodiments can solve the problem of finding a nearest neighbor in a database by a branch-and-bound search of a space-partitioned tree with incrementally increasing bounds, where the bound is guaranteed to be a lower-bound on the distance to a nearest neighbor. The various example embodiments can determine a lower-bound of the distance to a nearest neighbor based on the query, a current node in the space-partitioned tree, and a bound. One embodiment is a system that performs the following operations:
Determine whether or not the current node is a leaf node.
If so: return the distance to the node and information associated with the node.
If not:
   Determine a lower-bound estimate based on the node and the query point.
   Determine whether or not the lower-bound estimate exceeds the pruning bound.
   If so: return a result which indicates the lower-bound estimate.
   If not:
      Determine a temporary result corresponding to a lower-bound of a distance to the nearest neighbor based on at least one child node of the node, the query, and the bound.
      Determine an intermediate result based at least on the temporary result.
      Return a final result which indicates the intermediate result.

The intermediate result is typically based on the minimum of multiple temporary results corresponding to a lower-bound for multiple children of a node. The process of determining a child node from a parent node is typically based on a numbering system between a node and a child node. For example, the node might have number i and the child might have number 4i+1 for a quad-tree tree of hyper-rectangles. Note that a quad-tree of hyper-rectangles is based on two dimensional hyper-rectangles, which correspond to the two dimensions of a query point.

Typically, this system can be driven by another method and apparatus which gradually increases the current pruning bound until an answer to a query is found. Initially, the pruning bound is zero and the pruning bound can be updated to the global estimate (returned above) until the pruning bound does not increase. Once the pruning bound cannot further be increased, the nearest neighbor is guaranteed to have been found. Thus, this process is significantly different from previous approaches: instead of searching with increasingly tighter upper-bounds, the process of the various embodiments described herein involves searching with increasingly looser lower-bounds until the nearest neighbor is found.

Experiments show that the resulting search complexity using the embodiments described herein is a log of the size of the database. As such, the functionality of the embodiments described herein is beneficial for efficiently finding a nearest neighbor when the database (and corresponding space-partitioned tree) is extremely large.

The system of various embodiments can be used to prune more of a space-partitioned tree than previous approaches. Thus, a greater level of efficiency can be achieved. In particular, the various embodiments described herein are guaranteed never to explore below a node whose distance to a query point is greater than the distance from the query point to a nearest neighbor. The various embodiments described herein are innovative at least because no combination of the previous approaches will yield the embodiments described herein.

The system of various embodiments can be used to find a nearest neighbor efficiently in a large database. For example, the system of various embodiments can be used to find a nearest postal code based on a latitude and longitude, which can involve postal code databases with several hundred million postal codes.

One embodiment can be used with a prediction engine, which can predict geo-location based on information associated with an Internet Protocol (IP) address. The geo-location prediction is in the form of a latitude and longitude, for which the nearest postal code must be found. Postal codes are useful for most customers who prefer to target ads based on postal code rather than latitude and longitude.

An example embodiment can use a distance metric comprising the sum of the distances squared over each dimension where the difference is between the query point and a target candidate, where the distance involves a measure to a bounding hyper-rectangle corresponding to a bounding hyper-box of data. Each bounding hyper-rectangle can have one or more bounding hyper-rectangles located within it, thus forming a tree hierarchy which can be efficiently searched with particular embodiments described herein.

Other preferred embodiments involve determining the location of the query point relative to bounding hyper-rectangle and maintaining the location relative to the query point. For example, if the query point is determined to be to the left of a hyper-rectangle, the query point is guaranteed to be to the left of all the hyper-rectangles within the hyper-rectangle. This determination can be used to make the search for the nearest neighbor more efficient.

### DETAILED DESCRIPTION OF AN EXAMPLE EMBODIMENT

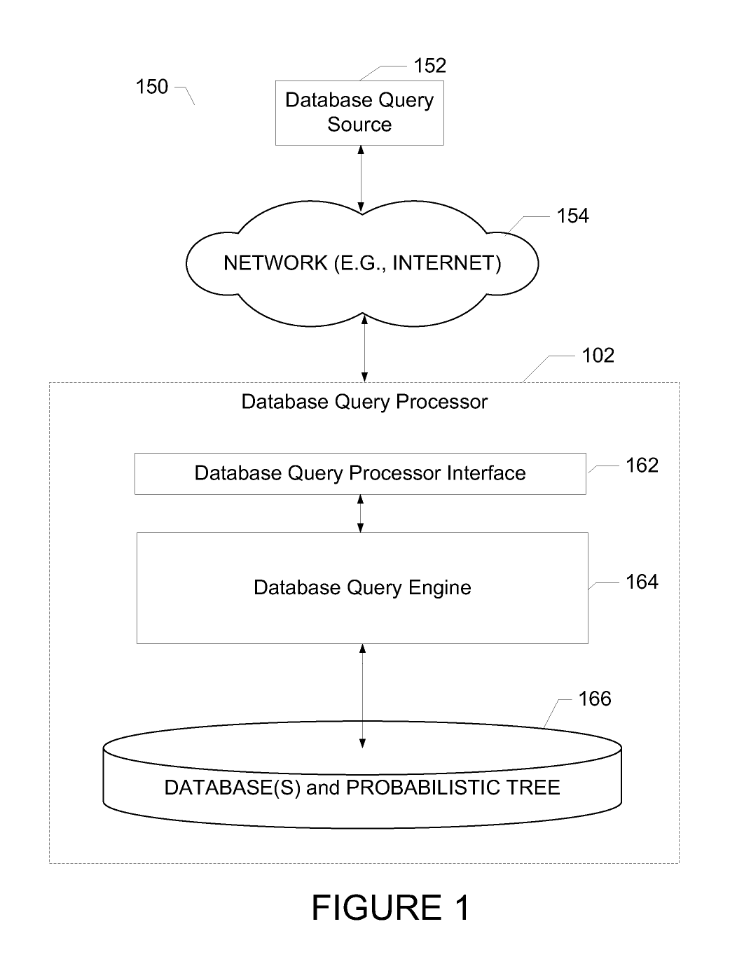

FIG. 1 illustrates a network diagram depicting a system 150 having a database query source 152 in network communication with a database query processor 100 and a database 166 via a data network 154, according to an example embodiment. Database query source 152 represents any computing entity, which may originate a query on a database, such as database 166. Database query source 152 can include a client system, a server system, an automated service, an autonomous network, or the like. Database query source 152 can also be a computing entity that is directly connected to the database query processor 100 and/or database 166 without the use of a data network.

The database 166 can be any conventional type of data repository. Additionally, the database 166 can be configured to include a probabilistic tree. The probabilistic tree can comprise a set of nodes, where each node is associated with a probability distribution function corresponding to one or more rows in the database. For example, the probability distribution function might be a multivariate normal, comprising a mean vector and a covariance matrix. The mean vector represents typical values for a row and the covariance matrix represents deviation associated with pairs of those typical values. Other distributions might have different parameters. Each node can have zero or more children and is also associated with a probability of the node given the parent node. Each node can also have an identifier associated with it, which facilitates retrieval of that associated information. The probabilistic tree for various embodiments can be built using various conventional methods. As described in more detail herein, various embodiments, implemented by the processing performed by the database query processor 100, provide a method and apparatus for facilitating finding a nearest neighbor in a database, such as database 166.

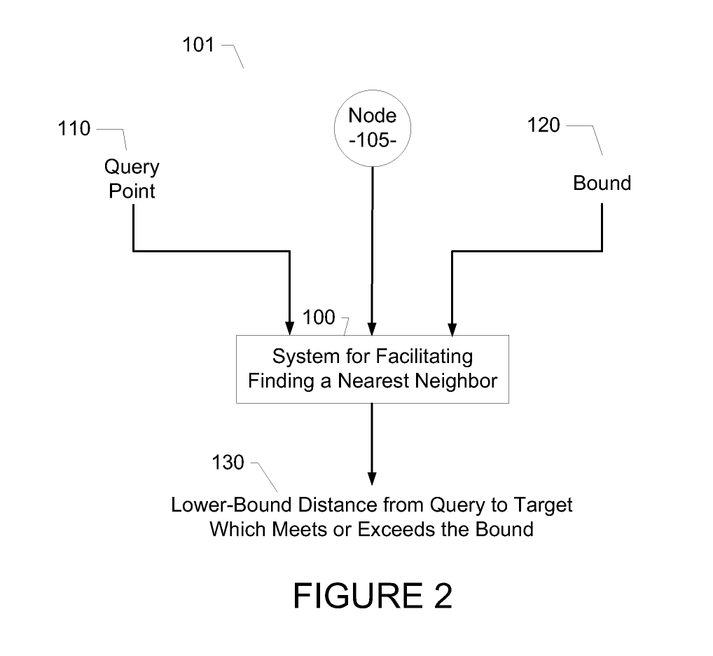

Referring now to FIG. 2, an overall view 101 illustrates the processing performed by an example embodiment. In the example embodiment as shown in FIG. 1, the database query processor 102 and its database query processor interface 162 can receive input from a database query source 152. As shown in FIG. 2, the system 100 can be used by or within the database query processor 102 to process data associated with the input from the database query source 152. The system 100 can receive as input a query point 110, a node 105, and a bound 120. The query point 110 is typically an n-dimensional vector. Nodes, such as node 105, store information such as the boundaries of a bounding hyper-rectangle or data associated with a nearest neighbor. The bound 120 corresponds to a distance that cannot be exceeded. The system 101 returns a result 130 comprising a lower-bound to the distance from the query to the nearest neighbor, where the distance meets or exceeds the bound.

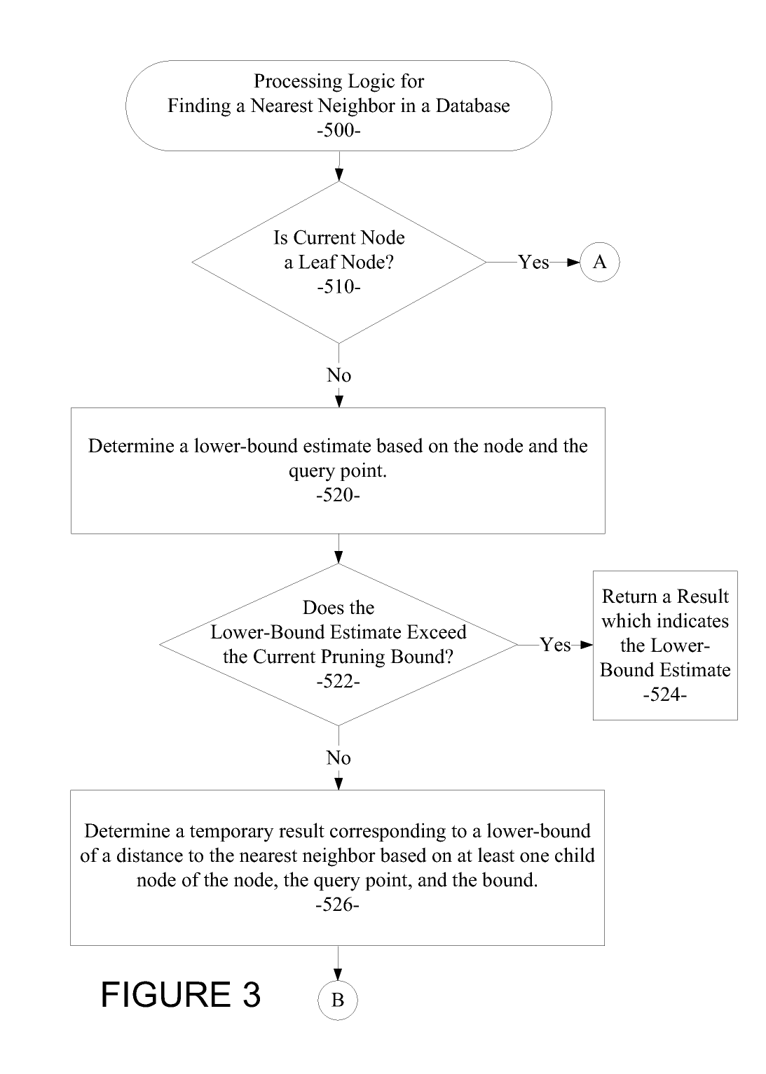

FIGS. 3 through 5 illustrate a flowchart showing the processing flow for finding a nearest neighbor in a database in an example embodiment. In the example embodiment, the system returns a result comprising a lower-bound to the distance from the query to the nearest neighbor, where the distance meets or exceeds the bound. This processing flow for an example embodiment is described in detail below.

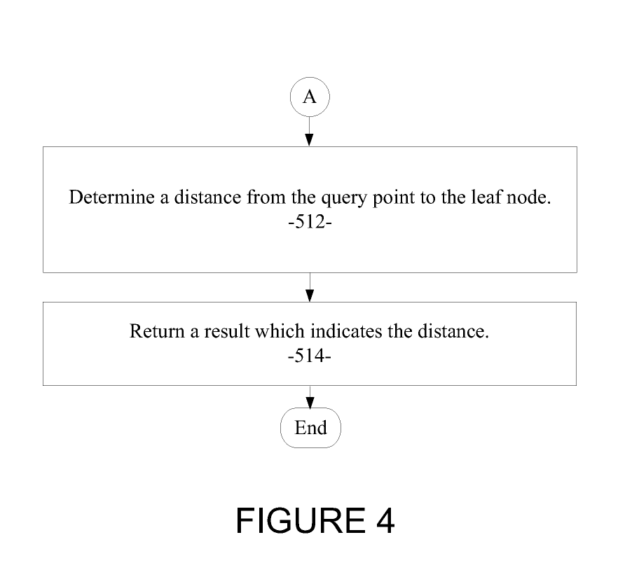

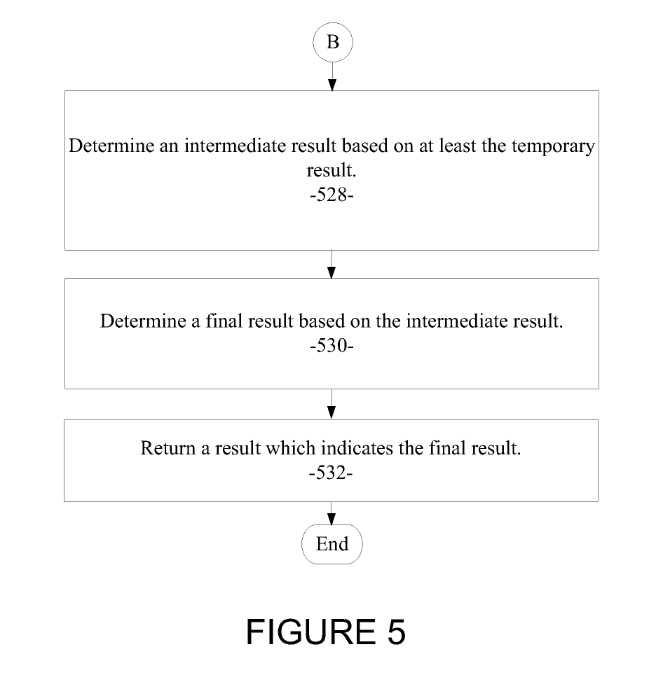

Referring to FIG. 3 at decision block 510, the current node is tested to determine if the current node is a leaf node. If the current node is a leaf node, processing continues at the bubble labeled A as shown in FIG. 4. If the current node is not a leaf node, processing continues at processing block 520. In processing block 520, processing is performed to determine a lower-bound estimate based on the node and the query point. The lower bound estimate is determined using the techniques described above. At decision block 522, the lower-bound estimate is tested to determine if the lower-bound estimate exceeds the current pruning bound. If the lower-bound estimate exceeds the current pruning bound, a result is returned indicating the lower-bound estimate in processing block 524. If the lower-bound estimate does not exceed the current pruning bound, processing continues at processing block 526. In processing block 526, processing is performed to determine a temporary result corresponding to a lower-bound of a distance to the nearest neighbor based on at least one child node of the node, the query point, and the bound. Processing then continues at the bubble labeled B as shown in FIG. 5.

Referring now to FIG. 4 at the bubble labeled A, it has been determined that the current node is a leaf node from the processing performed in decision block 510 shown in FIG. 3. In processing block 512, processing is performed to determine a distance from the query point to the leaf node. Finally, in processing block 514, processing is performed to return a result which indicates the distance.

Referring now to FIG. 5 at the bubble labeled B, it has been determined that the lower-bound estimate does not exceed the current pruning bound from the processing performed in decision block 522 shown in FIG. 3. In processing block 528, processing is performed to determine an intermediate result based on at least the temporary result. In processing block 530, processing is performed to determine a final result based on the intermediate result. Finally, in processing block 532, processing is performed to return a result, which indicates the final result.

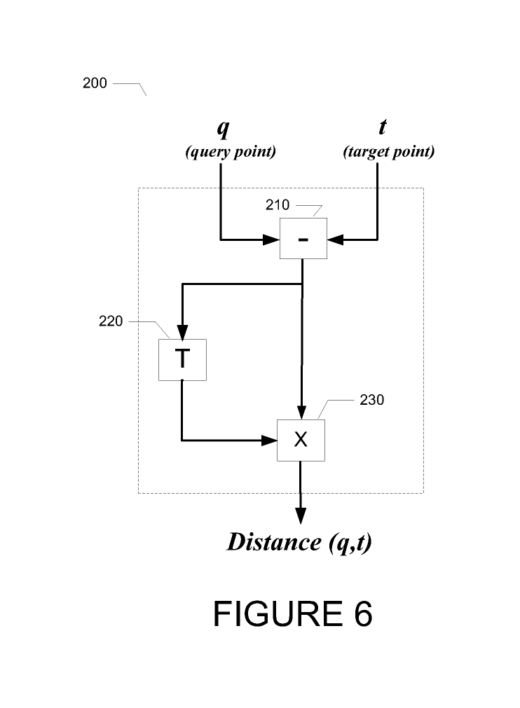

FIG. 6 illustrates an example embodiment 200 to determine the distance at a leaf node. FIG. 6 shows a mechanism 200 to determine a distance between a query point q, which represents a column vector and a target point t, which represents a column vector associated with a target at a leaf node.

As shown in FIG. 6, note that the symbol T in processing block 220 represents a transpose operation. Note also in the example embodiment that the leaf node is typically associated with other information that is returned in conjunction with the distance a leaf node. Other distance measures are possible. For example, a distance between a query point and a rectangle can be determined by finding the relative orientation of the query point to the rectangle: above-right, above-left, above-center, below-left, below-right, below-center, left, and right. Each of these orientations has a well-defined distance associated with it. For example, above-center is the distance from the query point directly below it.

As shown in FIG. 6, the difference between the query point q and the target point t is computed in processing block 210. This difference is transposed in processing block 220 and provided as an input to a multiply processing block 230. The non-transposed difference is also provided as an input to multiply processing block 230. Multiply processing block 230 computes the product of the transposed difference between query point q and the target point t and the non-transposed difference between query point q and the target point t in processing block 230. This product is provided as an output result of the processing of embodiment 200 as shown in FIG. 6. This result includes information indicating a distance between a query point q, which represents a column vector and a target point t, which represents a column vector associated with a target at a leaf node.

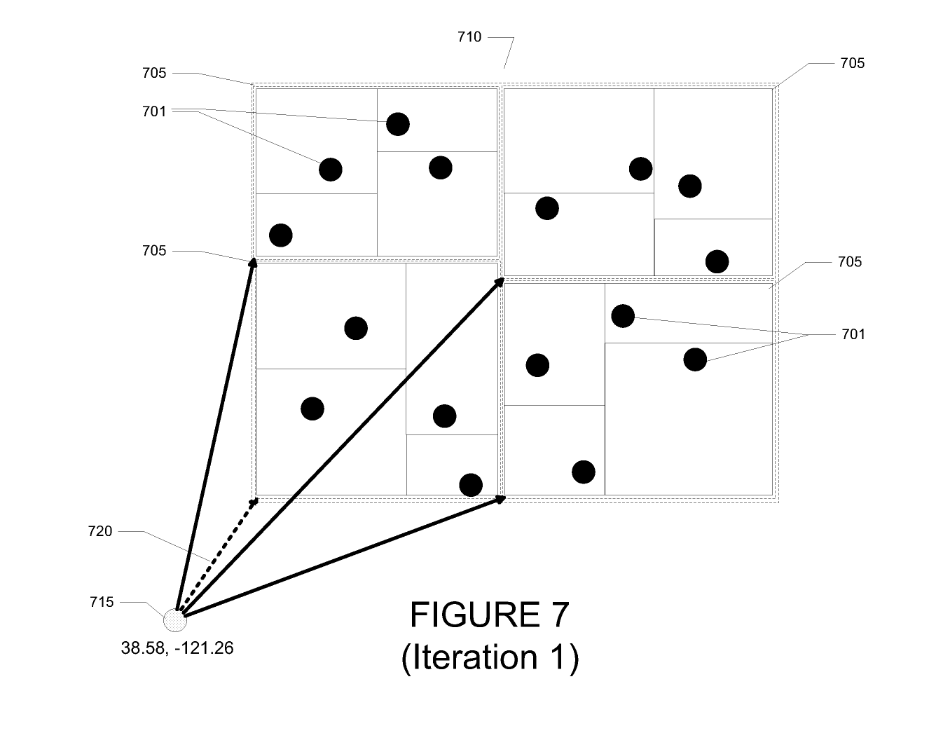

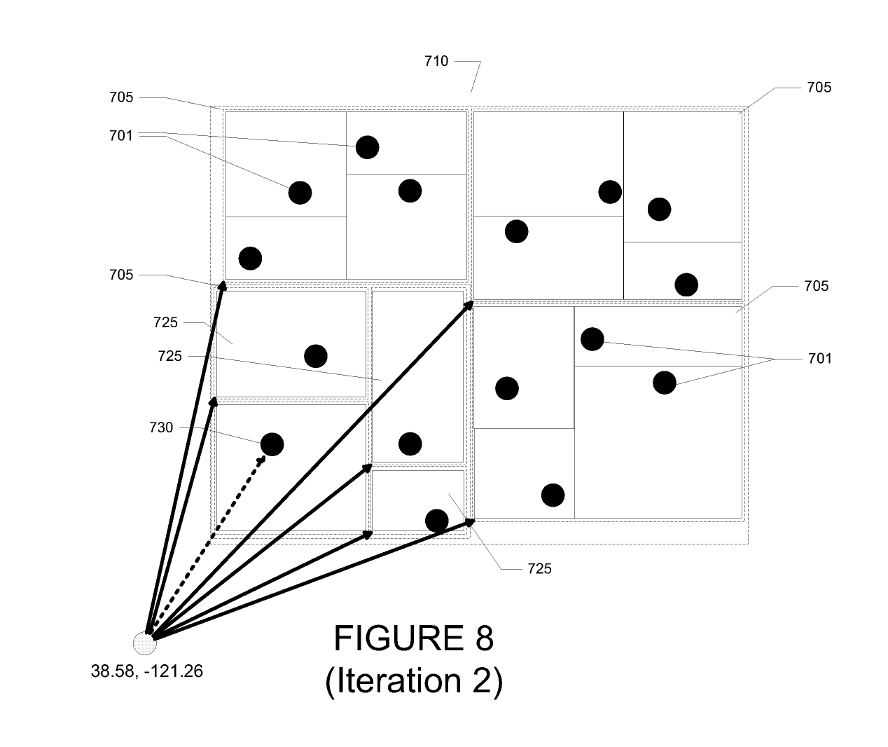

FIGS. 7 and 8 illustrate an example embodiment with a driver, which iterates the pruning bound from high to low. As shown in FIGS. 7 and 8, each black dot 701 corresponds to a data point, which in the example illustrated has two dimensions. The rectangles 705 represent bounding boxes (i.e., hyper-rectangles with the number of dimensions equal to two, in the illustrated example). The bounding boxes 705 form a hierarchy of boxes within boxes. For example, the largest box 710 contains four sub-boxes, represented by the dotted lines. Similarly, the sub-boxes can each contain a number of smaller boxes. An example query point 715 (e.g., 38.58, −121.26) is shown in this example outside of the largest box 710. As shown in FIG. 7 for a first iteration, the distance to each of the four sub-boxes 705 within the largest box 710 corresponds to the length of each of the arrows emanating from the example query point 715. The dotted arrow 720 corresponds to the distance to the nearest bounding box (i.e., the minimum distance or length of all the arrows, which corresponds to the minimum distances to each of the four bounding boxes 705). As shown in FIG. 7 for the first iteration, if the initial bound (i.e., the bound for the first iteration) is 0, the new bound corresponds to the distance to this nearest bounding box. Because this new bound exceeds the initial bound, the iterative process through the driver continues as shown in FIG. 8, except this time with the new bound. The new bound corresponds to the distance to the nearest bound box 705. This time as shown in FIG. 8, the minimum distance is taken over the distance to six bounding boxes (the three previous ones 705 and the three interior ones 725 of the left-most bounding box 705 containing four sub-boxes) and the distance to the lower-left black dot 730, which is the nearest neighbor within one of the four sub-boxes of the left-most bounding box 705. On the final iteration, the same distance is returned. In this case, the process can terminate as the nearest neighbor has been found. Typically, both the distance and the contents associated with the nearest neighbor can be returned.

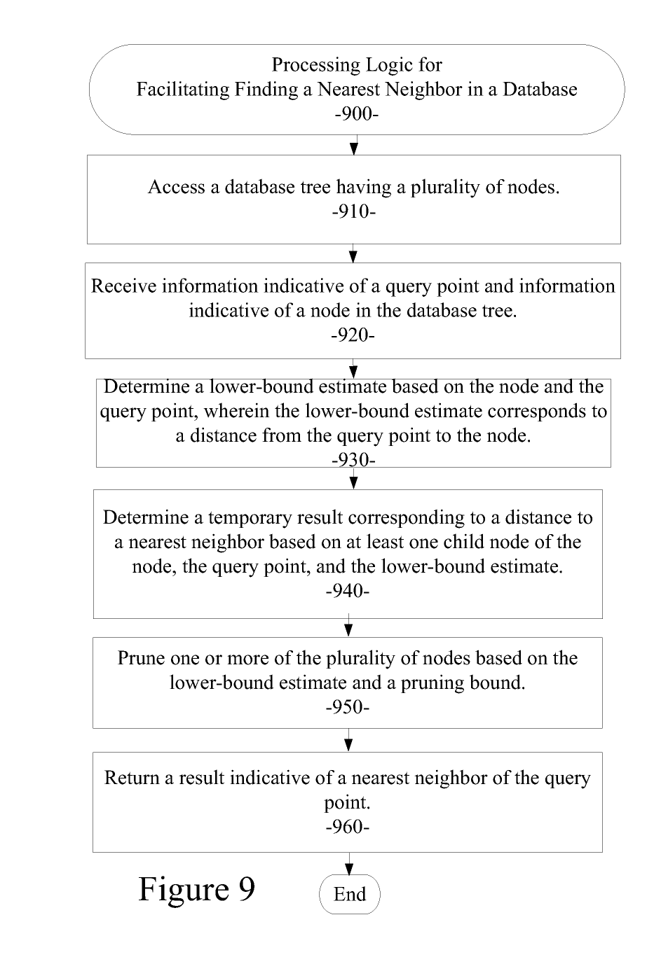

FIG. 9 illustrates a flowchart showing the processing flow for facilitating finding a nearest neighbor in a database in an example embodiment. Example embodiments include: accessing a database tree having a plurality of nodes (processing block 910); receiving information indicative of a query point and information indicative of a node in the database tree (processing block 920); determining, by use of a processor, a lower-bound estimate based on the node and the query point, wherein the lower-bound estimate corresponds to a distance from the query point to the node (processing block 930); determining, by use of the processor, a temporary result corresponding to a distance to a nearest neighbor based on at least one child node of the node, the query point, and the lower-bound estimate (processing block 940); pruning one or more of the plurality of nodes based on the lower-bound estimate and a pruning bound (processing block 950); and returning a result indicative of a nearest neighbor of the query point (processing block 960).

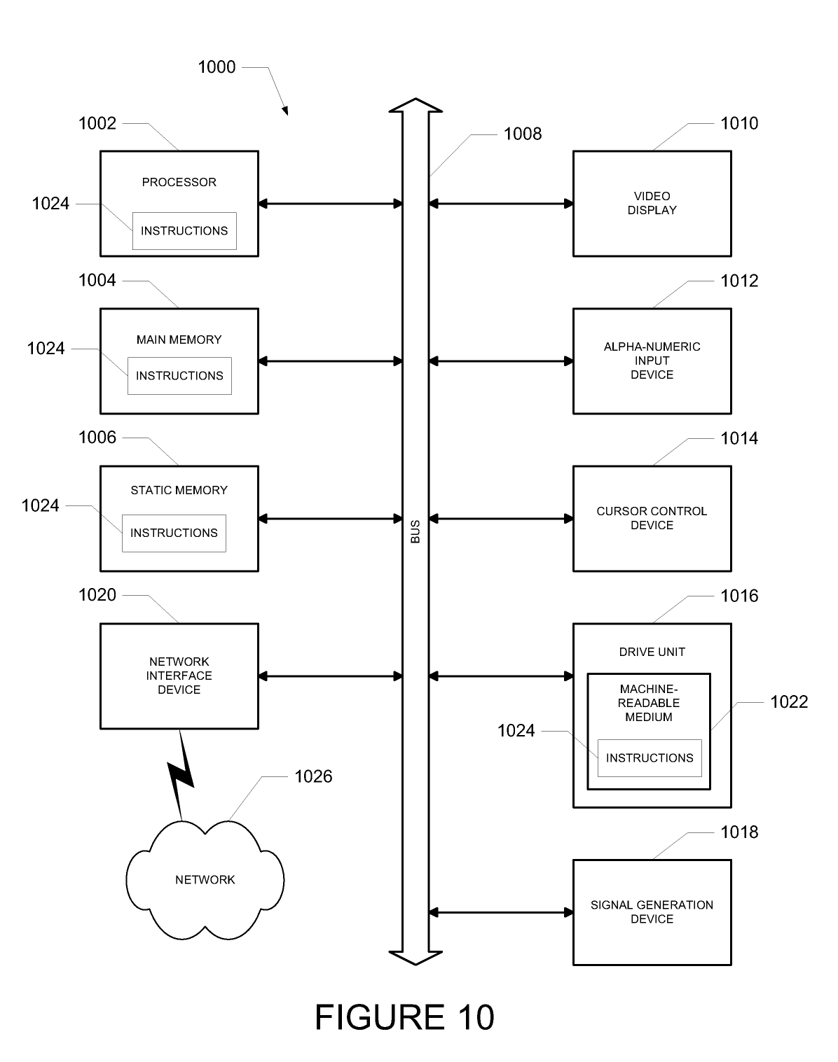

FIG. 10 shows a diagrammatic representation of a machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The instructions 1024 may also reside, completely or at least partially, within the main memory 1004, the static memory 1006, and/or within the processor 1002 during execution thereof by the computer system 1000. The main memory 1004 and the processor 1002 also may constitute machine-readable media. The instructions 1024 may further be transmitted or received over a network 1026 via the network interface device 1020.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In example embodiments, a computer system (e.g., a standalone, client or server computer system) configured by an application may constitute a “module” that is configured and operates to perform certain operations as described herein below. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any non-transitory medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media, and magnetic media.

As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The following description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

Thus, a method and apparatus for facilitating finding a nearest neighbor in a database have been described. Although embodiments have been described with reference to specific example embodiments, it will be evident that various modifications and changes may be made to these embodiments without departing from the broader spirit and scope of embodiments as expressed in the subjoined claims.

What is claimed is:

1. A method comprising:
accessing a database tree having a plurality of nodes;
receiving information indicative of a query point and information indicative of a node in the database tree;
determining, by use of a processor, a lower-bound estimate based on the node and the query point, wherein the lower-bound estimate corresponds to a distance from the query point to the node;
determining, by use of the processor, a temporary result corresponding to a distance to a nearest neighbor based on at least one child node of the node, the query point, and the lower-bound estimate;
pruning one or more of the plurality of nodes based on the lower-bound estimate and a pruning bound; and
returning a result indicative of a nearest neighbor of the query point.

2. The method of claim 1 including determining a distance from the query point to a leaf node.

3. The method of claim 1 wherein the node is not a leaf node.

4. The method of claim 1 including determining a distance from the query point to a plurality of bounding boxes corresponding to the node.

5. The method of claim 4 wherein each of the plurality of bounding boxes corresponding to the node includes a hierarchical arrangement of sub-boxes.

6. The method of claim 4 including determining a minimum distance from the query point to each of the plurality of bounding boxes corresponding to the node.

7. The method of claim 4 including determining a minimum distance from the query point to each of a plurality of sub-boxes of each of the plurality of bounding boxes corresponding to the node.

8. The method of claim 1 wherein the query point corresponds to a database query.

9. A system comprising:
a processor;
a database query processor interface, in data communication with the processor, to receive a query point and information indicative of a node in a database tree; and
a database query processor, in data communication with the processor, to:
access a database tree having a plurality of nodes;
receive information indicative of a query point and information indicative of a node in the database tree;
determine, by use of the processor, a lower-bound estimate based on the node and the query point, wherein the lower-bound estimate corresponds to a distance from the query point to the node;
determine, by use of the processor, a temporary result corresponding to a distance to a nearest neighbor based on at least one child node of the node, the query point, and the lower-bound estimate;
prune one or more of the plurality of nodes based on the lower-bound estimate and a pruning bound; and
return a result indicative of a nearest neighbor of the query point.

10. The system of claim 9 being further configured to determine a distance from the query point to a leaf node.

11. The system of claim 9 wherein the node is not a leaf node.

12. The system of claim 9 being further configured to determine a distance from the query point to a plurality of bounding boxes corresponding to the node.

13. The system of claim 12 wherein each of the plurality of bounding boxes corresponding to the node includes a hierarchical arrangement of sub-boxes.

14. The system of claim 12 being further configured to determine a minimum distance from the query point to each of the plurality of bounding boxes corresponding to the node.

15. The system of claim 12 being further configured to determine a minimum distance from the query point to each of a plurality of sub-boxes of each of the plurality of bounding boxes corresponding to the node.

16. The system of claim 9 wherein the query point corresponds to a database query.

17. An article of manufacture comprising a non-transitory machine-readable storage medium having machine executable instructions embedded thereon, which when executed by a machine, cause the machine to:
access a database tree having a plurality of nodes;
receive information indicative of a query point and information indicative of a node in the database tree;
determine, by use of a processor, a lower-bound estimate based on the node and the query point, wherein the lower-bound estimate corresponds to a distance from the query point to the node;
determine, by use of the processor, a temporary result corresponding to a distance to a nearest neighbor based on at least one child node of the node, the query point, and the lower-bound estimate;
prune one or more of the plurality of nodes based on the lower-bound estimate and a pruning bound; and
return a result indicative of a nearest neighbor of the query point.

18. The article of manufacture of claim 17 being further configured to determine a distance from the query point to a plurality of bounding boxes corresponding to the node.

19. The article of manufacture of claim 18 wherein each of the plurality of bounding boxes corresponding to the node includes a hierarchical arrangement of sub-boxes.

20. The article of manufacture of claim 18 being further configured to determine a minimum distance from the query point to each of the plurality of bounding boxes corresponding to the node.
